(19) United States
(12) Patent Application Publication
(10) Pub. No.: US 2008/0199770 A1
(43) Pub. Date: Aug. 21, 2008

(54) Apparatus, System and Method For Battery Connections

(75) Inventors: George Marmaropoulos, Yorktown Heights, NY (US); Giang Vu, Peekskill, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,497

(22) PCT Filed: Apr. 20, 2006
(86) PCT No.: PCT/IB2006/051231

§ 371 Date: Sep. 24, 2007

Related U.S. Application Data
(60) Provisional application No. 60/674,496, filed on Apr. 25, 2005.

(51) Int. Cl. H01M 2/06; H01M 2/30

(52) U.S. Cl. 429/178

(57) ABSTRACT

An apparatus, system and method for establishing electrical communication between various power sources, as well as with a variety of different electronic applications including smart fabrics having electrical characteristics, such as a conductive fiber network and/or electronic devices/systems, associated therewith is provided in which a connecting element (22, 122, 222) is utilized to accomplish a threaded connection between two or more batteries (10, 110, 210, 310) and/or various other electronic applications (e.g., smart fabric applications) via one or more through channels (20, 120, 220) associated with each battery. The threaded connection, once appropriately established facilitates electrical communication by and between the various batteries and/or electronic applications as needed.

The present disclosure is directed to portable energy sources such as batteries and more particularly, to battery connections.

Portable power sources like batteries are well known and available in various standard forms and voltages. These energy sources are often custom made so as to suit a particular application (e.g., a watch battery, a cell phone battery, a laptop battery, etc.). With respect to conventional batteries, it is significant that in many applications the use of more than one battery is often necessary. For example, applications requiring an increase in voltage output may necessitate two or more batteries being connected in series. Alternatively, applications requiring an increase in current could require two or more batteries being connected in parallel. In either case, the batteries are typically connected with the aid of a predefined battery compartment. These compartments are limited in that they are predefined for only a limited number of battery connections. In addition, these conventional battery compartments, in order to maintain the integrity of the battery connections, typically include extra components and are generally rigid in nature. Accordingly, the use of such compartments necessarily inhibits the freedom of design and application with respect to portable power sources.

In the design and use of smart fabrics, for example, it is often desirable that the natural characteristics (e.g., drape, flexibility, durability, etc.) associated with the fabric be preserved. Further, in certain smart fabric applications (e.g., wearable electronics) it is important that the smart fabric be washable. Accordingly, it is a disadvantage that often methods for connecting different energy sources to fabric require the use of awkward, and sometimes rigid, bulky and/or unsightly battery compartments. It follows then that there is a need for an apparatus, system and/or method for connecting batteries or the like so as to reduce or eliminate the need for a battery compartment. Moreover, there is a need for an apparatus, system and/or method for connecting, as desired, an energy source to fabric in a manner that is compatible with the fabric style.

Hence, according to the present disclosure a portable power source in, for example, the form of a battery is disclosed in which one or more through channels enable the battery to be effectively connected to one or more additional batteries and/or to various fabrics including, for example, smart fabrics having one or more electronic devices and/or systems associated therewith. The battery, once appropriately connected to the fabric via the through channel, can provide energy to various electronic applications associated with the fabric as needed.

According to the present disclosure, an illustrative battery having a body suitable for accommodating an energy source and including a pair of terminals that are operatively associated with the energy source is provided with at least one through channel suitable for accommodating at least one connecting element. The connecting element, according to a beneficial aspect of the present disclosure, is preferably a resiliently flexible member that can be either insulative or conductive depending on its application. In another beneficial aspect of the present disclosure, the connecting element can be either integrated in or attached to a fabric including, for example, various garment fabric types. Thus, in an advantageous aspect of the present disclosure, one or more batteries can be securely connected to or integrated with a piece of fabric associated with a garment (e.g., a pocket, a sleeve, a collar, a seam, or the like), as desired, to provide power to any one or more electronic devices and/or systems directly or indirectly associated with such garment. For example, with particular respect to smart fabrics, which fabrics typically include integrated conductive fibers and/or the like suitable to facilitate different electronic operations (e.g., electrical communication by and between one or more wearable electronic devices associated with the fabric), these fabrics can have conductive contacts for electrically communicating with the battery via the battery terminals. That is, the connecting element, in cooperation with the battery through channel, can be used to connect together at least one terminal of the battery and at least one conductive contact of the fabric so as to facilitate electrical communication therebetween as desired.

A system, according to an advantageous feature of the present disclosure, includes (i) at least one battery having a body with terminals operatively connected to a power source, and (ii) at least one connecting element cooperative with the battery via at least one channel in the battery body. The terminals, in one exemplary embodiment of the present disclosure, are at least substantially external to the battery body and each connecting element nonconductive. While, in another exemplary embodiment of the present disclosure, the terminals are exposed at least substantially internally with each terminal corresponding to one of two channels suitable for accommodating at least one conductive connecting element. At least one advantage provided by the illustrative system of the present disclosure is found in that two or more batteries can be easily and effectively connected so as to increase provided voltage and/or current.

An advantageous method, according to another illustrative aspect of the present disclosure, includes the steps of: (i) providing a first battery that has a pair of terminals and that includes at least one through channel, and (ii) passing a connecting element through the first battery through channel so that the first battery is at least partially supported by the connecting element. The method may further include a steps of (iii) passing the connecting element through a through channel of a second battery, the second battery also having a pair of terminals, and (iv) bringing one of the terminals of the second battery into contact with one of terminals of the first battery so as to establish a connection therebetween. The connecting element, according to an advantageous aspect of the present disclosure, is suitable for supporting any number of battery connections, and moreover, is suitable for operatively connecting at least one battery to an electrical device or system so as to effectively provide power thereto.

Additional advantageous features, aspects and functions relating to the present disclosure will be apparent from the detailed description which follows, particularly when reviewed together with the appended figures, which figures are referenced to assist those of ordinary skill in the art to which the subject matter of the present disclosure appertains to better understand the exemplary embodiments of the present disclosure, wherein:

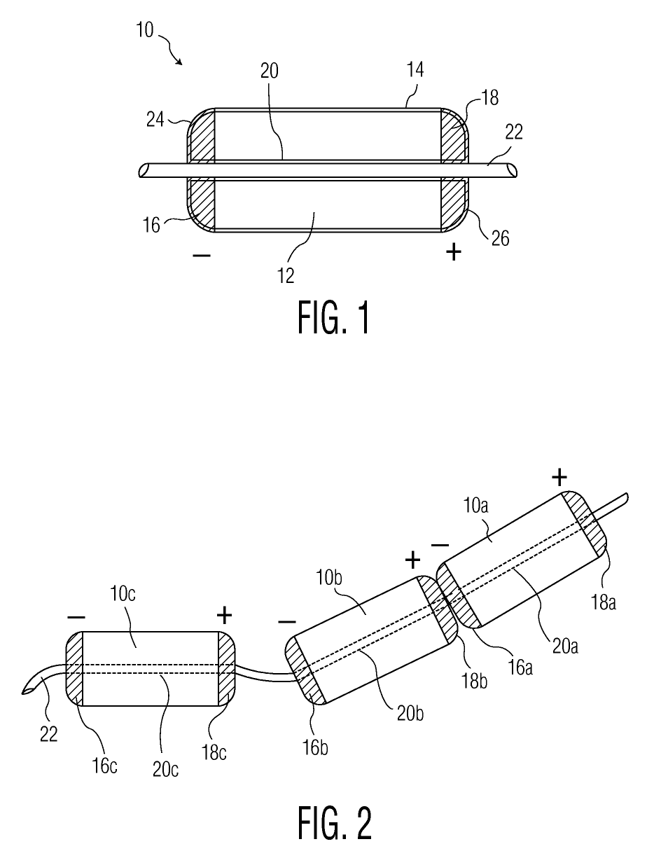

FIG. 1 is a cross-sectional view of an exemplary battery according to an illustrative embodiment of the present disclosure;

FIG. 2 is a schematic representation of an exemplary battery connecting system in accordance with an illustrative aspect of the present disclosure;

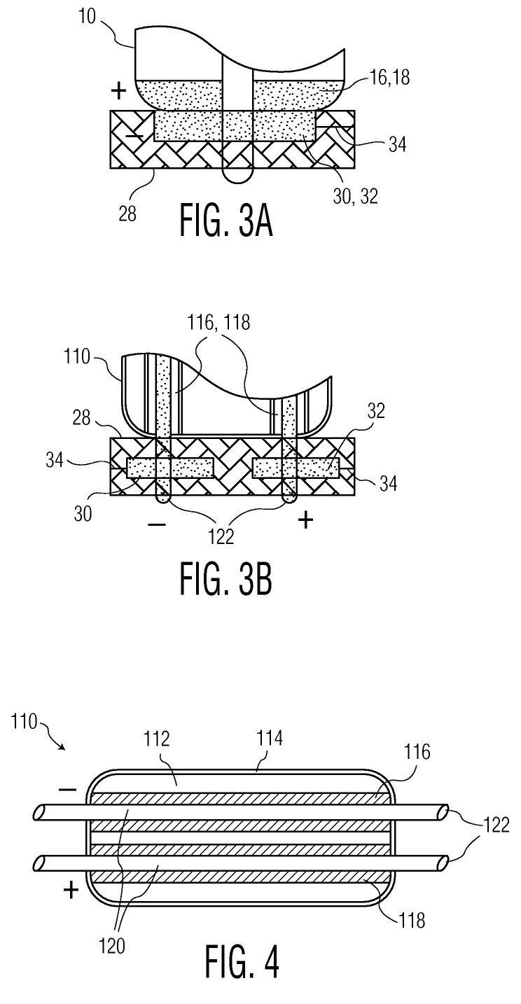

FIGS. 3a and 3b are schematic cross-sectional views of exemplary fabric arrangements according to an illustrative aspect of the present disclosure;

FIG. 4 is a cross-sectional view of an exemplary battery according to an illustrative embodiment of the present disclosure;

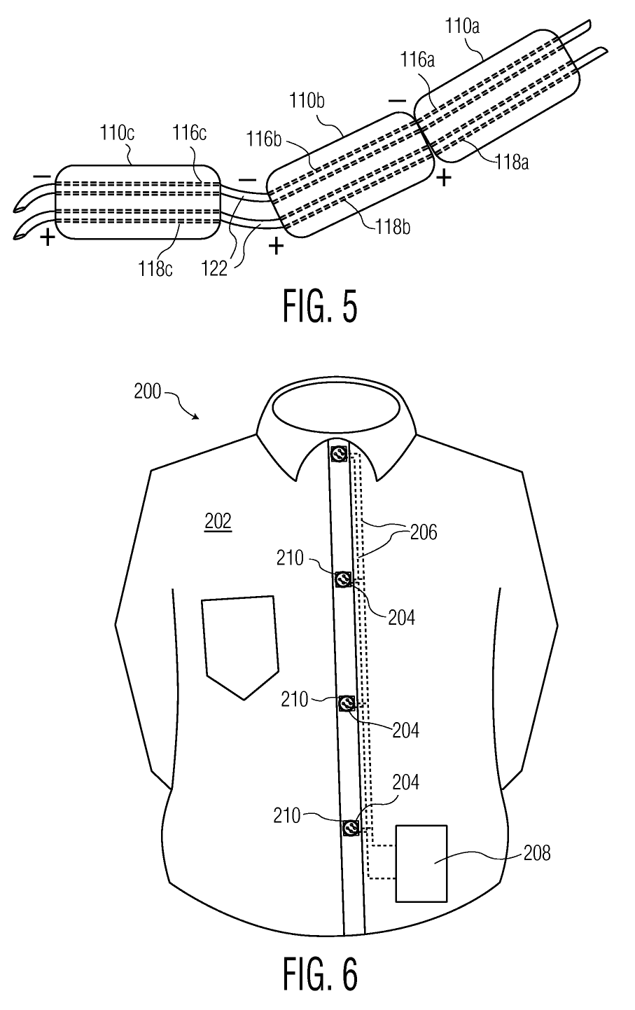

FIG. 5 is a schematic representation of an exemplary battery connecting system in accordance with an illustrative aspect of the present disclosure;

FIG. 6 is a schematic representation of an exemplary smart garment according to an illustrative aspect of the present disclosure;

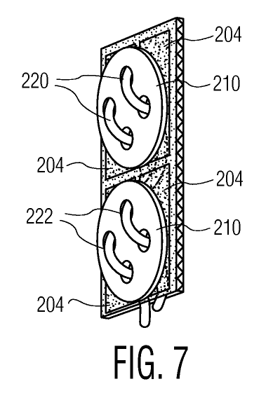

FIG. 7 is a perspective view of an exemplary battery connecting system compatible with the garment of FIG. 6 according to an illustrative aspect of the present disclosure;

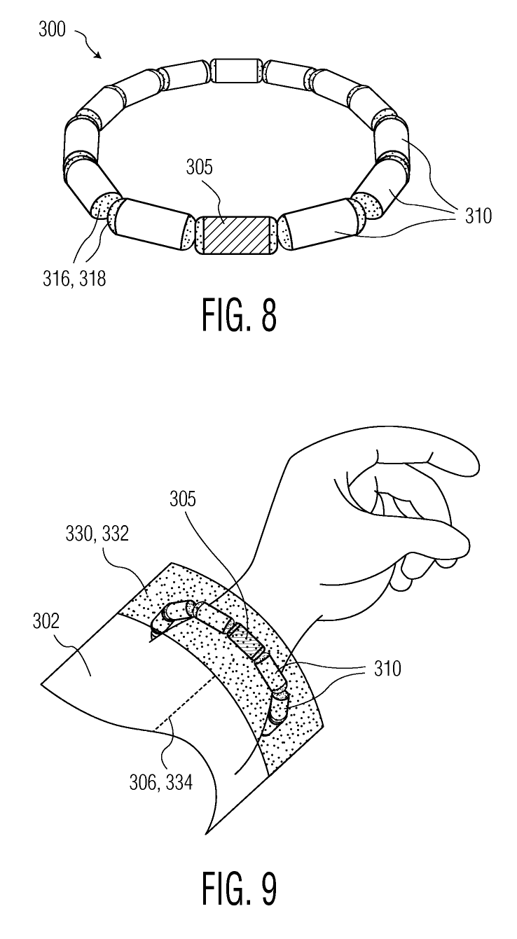

FIG. 8 is a schematic representation of an exemplary accessory according to an illustrative aspect of the present disclosure; and

FIG. 9 is a perspective view of the accessory of FIG. 8 demonstrating an exemplary application in use thereof according to an illustrative aspect of the present disclosure.

With reference to the drawings, it should be understood that notwithstanding the following detailed description of the various exemplary embodiments and/or aspects of the present disclosure referring to the drawings which form a part hereof, other additional and/or alternative embodiments, aspects and/or features may equally be used without departing from the scope of the present disclosure as the advantageous features of the present disclosure may be employed in any of a variety of applications including, for example, any electrical application requiring a power source.

With initial reference to FIG. 1, there is shown a battery 10 according to an exemplary embodiment of the present disclosure. As shown, the battery 10 includes an energy source 12, a body 14 for accommodating the energy source 12, a pair of terminals 16, 18 accessible from without the body 14 and operatively associated with the energy source 12, and at least one through channel 20 suitable to receive and accommodate at least one connecting element 22.

The energy source 12, in an aspect of the present disclosure, can derive energy from a variety of chemicals reactions such as, for example, conventionally provided by zinc-carbon batteries, alkaline batteries, lithium photo batteries, rechargeable lead-acid batteries, rechargeable nickel-cadmium batteries, rechargeable nickel-metal hydride batteries, rechargeable lithium-ion batteries, zinc-air batteries, zinc-mercury oxide batteries, silver-zinc batteries, and/or metal-chloride batteries. As will be readily understood to those skilled in the pertinent art from the present disclosure, the energy source 12 may equally derive energy or power from any of a variety of other means. For example, the energy source 12 may derive energy from an appropriate fuel cell arrangement. In addition, the energy source 12, in a preferred aspect of the present disclosure, can be rechargeable such as by induction or inductive charging.

The body 14, although shown as having a relatively elongated substantially tubular body, may, in other aspects of the present disclosure, have any of a variety of other forms and/or configurations suitable for accomplishing different aesthetic and/or functional effects. In addition, the body 14 can be formed of any of a variety of preferably non-conductive materials, which may likewise facilitate accomplishing different aesthetic and/or functional effects. The body 14 is preferably an integral structure that can be made to be water resistant. The body 14, in aspects of the present disclosure (not shown), can include various control features such as, for example, a power flow control capable of controlling the provided voltage and/or current. For example, such a control could have predefined voltage output settings associated therewith (e.g., 1.25V, 1.5V, 3V, 5V, 6V, 9V, etc.). As will be readily apparent to those skilled in the pertinent art, the control may take any of a variety of different forms including, for example, a button, a dial or a sliding mechanism.

The terminals 16, 18, as previously stated, are operatively associated with the energy source 12 and, in an aspect of the present disclosure, can be accessed from without the body 14. The terminals 16, 18 operate to facilitate transferring power from the energy source 12 located in the body 14 to various applications, systems and/or devices external to the body 14. According to one aspect of the present disclosure, the terminals 16, 18 are preferably remote relative to each other and at least substantially external to the body 14. For example, as depicted in FIG. 1, the terminals 16, 18 can be located at opposite ends or sides of the body 14 with one terminal 16 defining a positive pole and the other terminal 18 defining a negative pole. Alternatively, in another aspect of the present disclosure, discussed in more detail below with respect to FIG. 4, the terminals are relatively adjacent and preferably exposed substantially internally to a body.

As demonstrated via FIG. 1, according to an illustrative embodiment of the present disclosure, at least one through channel 20 preferably traverses the extent of the body 14 so that such through channel is associated with each terminal 16, 18 at least in that each end 24, 26 thereof preferably opens proximate one of the pair of terminals 16, 18. As shown, according to an advantageous aspect of the present disclosure, the through channel 20 is centrally located so that the body 14 is symmetric thereabout. This centrally disposed through channel 20 preferably facilitates a more effective battery-to-battery or terminal-to-terminal connection as well as a more efficient load or weight distribution about a connecting element 22. Alternatively, as will be readily appreciated by those skilled in the pertinent art from the present disclosure, the through channel 20 needs not be centrally disposed, notwithstanding the benefits associated therewith. For example, the through channel 20 can be disposed or located so that the body 14 is asymmetric thereabout. Further, the through channel 20 can be open and extend along an edge or perimeter of the body 14 (not shown) so as to facilitate a snap-fit type engagement with the connecting element 22. In still other aspects of the present disclosure, such as those discussed infra with respect to FIG. 4, multiple channels can be similarly arranged relative to the body so as to accomplish any of a variety of desired effects.

Referring still to FIG. 1, the connecting element 22, in an advantageous aspect of the present disclosure, is preferably resiliently flexible. As will be readily understood by those skilled in the pertinent art from the present disclosure, the connecting element 22 can have various degrees of flexibility associated therewith (e.g., rigid to flaccid) in order to effectuate different applications in use. For instance, in a preferred aspect of the present disclosure, the connecting element 22 is suitable for being integrated in and/or attached to various fabrics. For example, referencing FIGS. 3a and 3b, the connecting element 22 may advantageously be associated with a fabric 28 in a manner to facilitate at least one battery 10 being securely connected to or integrated with such fabric 28 so as to enable power to be provided to any one or more electronic devices and/or systems tied either directly or indirectly to the fabric 28. That is, according to a beneficial aspect of the present disclosure, a fabric 28 including integrated conductive fibers and/or the like suitable to facilitate various electronic operations (e.g., electrical communication by and between one or more wearable electronic devices/systems) can be provided with one or more conductive contacts 30, 32 suitable for electrically communicating with the battery 10 via the connecting element 22 in cooperation with the battery through channel 20 and terminals 16, 18. The connecting element 22 thus is operable, at least in part, to connect least one battery terminal 16, 18 together with at least one corresponding conductive contact 30, 32 of the fabric 28 to facilitate electrical communication therebetween as desired.

The conductive connection between the battery 10 and the fabric 28, according to the present disclosure, may be accomplished in varied ways. For example, in the exemplary embodiment of the present disclosure shown in FIGS. 1 and 2, the connecting element 22 is preferably insulative in nature so as to not interfere with the terminals 16, 18 and conductive contacts 30, 32 when operatively used bring and hold a terminal 16, 18 together with the appropriate corresponding conductive contact 30, 32 as for example shown in FIG. 3a. Alternatively, in the exemplary embodiment of the present disclosure shown in FIGS. 4 and 5, the connecting elements 122, in contrast, are preferably conductive in nature in order to electrically interact or communicate with terminals 116, 118 and conductive contacts 30, 32 when operatively used to bring and hold a terminal 116, 118 together with the appropriate corresponding conductive contact 30, 32 of fabric 28 as for example shown in FIG. 3b.

The fabric 28, according to a preferred aspect of the present disclosure, is thus not only suitable for cooperating with batteries 10, 110, but is also suitable for use in association with various electronic applications in general, and preferably, with wearable electronic applications. The fabric 28, according to the present disclosure, can be formed from any type of material whether manmade (e.g., rubber, Mylar, polyurethane, etc.), natural (e.g., cotton, wool, silk, etc.), or composite (e.g., polypyrrole/nylon, polypyrrole/lycra, polypyrrole/polyester, etc.), including all materials typically used in the manufacture of clothing.

As demonstrated in FIGS. 3a and 3b, the fabric 28 includes conductive contacts 30, 32 preferably suitable for cooperating with terminals 16, 18, 116, 118 either directly or indirectly via connecting elements 22, 122. In addition, the fabric 28 preferably includes conductive tracks or fibers 34 operatively connectable to one or more electronic applications associated with the fabric 28. The conductive fibers 34, according to a preferred aspect of the present disclosure, cooperate with the conductive contacts 30, 32 so as to connect any one or more electronic application associated with the fabric 28 to the battery 10, 110.

The conductive contacts 30, 32 and/or conductive fibers 34 can be fashioned from any of a variety of materials having conductive characteristics associated therewith. For example, the conductive contacts 30, 32 and/or conductive fibers 34 can be fashioned using flexible metal coated materials including woven, non-woven, and/or knits, filaments, foils, and yams, conductive polymer coated materials, conductive graphitized materials, conductive gel coated materials, cotton, lycra, spandex, neoprene, polyester, rubber extruded materials, polypyrrole/lycra materials, polypyrrole/nylon materials, polypyrrole/polyester materials, any conjugated polymer, ion-implanted polymers and/or any combination of the same. Further, the conductive contacts 30, 32 and/or conductive fibers 34 can be formed using any of a variety of known textile manufacturing techniques including, for example, various weaving, knitting, sewing, coating, and/or injecting techniques. Still further, the conductive contacts 30, 32 and/or conductive fibers 34 can have any of a variety of different shapes, sizes and/or configurations so as to be complementary with terminals associated with different battery configurations. The conductive contacts 30, 32 and conductive fibers 34, according to a beneficial aspect of the present disclosure, have characteristics suitable to provide appropriate flexibility and durability to withstand the stresses associated with the manufacture and use of a variety of different types of textile constructions.

It is noted that the conductive contacts 30, 32 and/or conductive fibers 34, in other aspects of the present disclosure, may be fashioned from a combination or mesh of conductive and non-conductive fibers using any known conventional method for weaving, sewing and/or knitting. In these aspects, each fiber can have any of a variety of forms and can be any of a variety of materials and/or combination of materials appropriate to accommodate different desired electronic applications.

Turning to FIGS. 2 and 5, according to an advantageous aspect of the present disclosure, a system including at least one connecting element 22, 122 and at least one battery 10, 110 preferably allows not only for one or more batteries 10, 110 to be operatively connected either directly or indirectly to an electronic device and/or system, but also enables a set of two or more batteries to be easily connected in series or in parallel so as to increase provided voltage or current as desired. For example, as shown in FIG. 2, a number of batteries such as, for example, battery 10 can be conductively connected in series to provide increased voltage. That is, the connecting element 22 can be passed through a through channel 20a of a first battery 10a so that such battery is supported thereby. Once the first battery 10a is threaded over the connecting element 22, a second battery 10b can likewise be threaded over the connecting element 22 via a through channel 20b thereof. Once the second battery 10b is threaded over the connecting element 22, the first battery 10a and the second battery 10b can be brought into conductive contact via corresponding terminals 16a, 18b thereof as shown. Any number of additional batteries may be similarly threadingly connected as desired. Once a desired number of batteries have been connected via the connecting element 22, such connecting element can be used to, for example, directly or indirectly connect the set of batteries to one or more devices/systems so as to provide increased voltage thereto as appropriate.

Additionally, as shown in FIG. 5, a number of batteries such as, for example, battery 110 of FIG. 4 can be conductively connected in parallel to provide increased current. Here two conductive connecting elements 122 can be passed through conductive through channels 120a of a first battery 110a so that such battery is at least substantially supported thereby. Any number of additional batteries may likewise be threaded over the two conductive connecting elements 122 as desired. Once a desired number of batteries have been conductively connected via the two connecting elements 122, such connecting elements can be used, like connecting element 22, to directly or indirectly connect the set of batteries to one or more devices/systems so as to provide increased current thereto as appropriate.

As will be readily recognized by those skilled in the pertinent art from the present disclosure, the system may advantageously allow for the easy removal or disengagement of a battery from a connecting element for recharging and/or replacement. In addition, it will also be appreciated that the system is well suited for a wide variety of electronic applications including, for example, different wearable electronic applications such as electronic fashion accessories worn for decorative and/or functional purposes.

With reference now to FIG. 4, a battery in accordance with an exemplary embodiment of the present disclosure is indicated generally by reference numeral 110. The battery 110 has similar features to battery 10 previously discussed with respect to FIG. 1, and therefore, to the extent appropriate, like reference numerals preceded by the numeral “1” are used to indicate similar elements. As shown, the battery 110 includes an energy source 112, a body 114 for accommodating the energy source 112, a pair of terminals 116, 118 accessible from without the body 114 and operatively associated with the energy source 112, and at least two through channels 120 each suitable to receive and accommodate at least one conductive connecting element 122. Further, as previously alluded to, terminals 116, 118 are preferably exposed at least substantially internally to the body 114 with each terminal corresponding to one of the two through channels 120. Thus, the conductive connecting elements 122 are not only suitable for supporting one or more batteries 110, but are also preferably suitable to electrically interact or communicate both with terminals 116, 118 as well as with remote conductive contacts (e.g., contacts 30, 32 of FIGS. 3a and 3b) either directly or indirectly associated with an electronic device and/or system requiring power. It will be readily appreciated by those skilled in the pertinent art from the present disclosure that the remote conductive contacts can take any of a variety of forms including those conventionally known as well as those yet to be discovered and/or developed. Additionally, connecting elements 122, in certain aspects of the present disclosure (not shown), can include and/or cooperate with any of a variety of adapting means so as to increase both freedom of design and application in use.

Having identified and discussed various illustrative embodiments, aspects and features associated with the apparatus, system and method of the present disclosure, it will be readily appreciated that such apparatus, system and method is/are particularly well suited for providing a portable means for energizing a wide variety of electronic applications. More particularly, the apparatus, system, and method of the present disclosure is/are compatible for use with garment, upholstery, and other textile products, as well as with the various accessories typically associated therewith. For example, as demonstrated by way of FIGS. 6 and 7, according to a beneficial aspect of the present disclosure, a smart garment can be provided with energy via one or more of the presently disclosed batteries associated therewith. Additionally, as demonstrated via FIGS. 9 and 10, an accessory product can be defined and/or powered by one or more of the presently disclosed batteries.

Referring to FIG. 6, a smart garment according to an illustrative aspect of the present disclosure is indicated generally by reference numeral 200. The garment 200 is, for illustrative purposes only, represented as a shirt 202. The garment 200 equally may take the form of any of a variety of other garments. The shirt 202, as shown, preferably includes one or more conductive contacts 204 as well as conductive tracks 206 suitable to connect the conductive contacts 204 to at least one wearable electronic application 208 associated with the shirt 202. As shown, one or more batteries 210 such as presently disclosed can be operatively connected to the shirt 202 so as to energize the application 208 via the conductive contacts 204 and conductive tracks 206. That is, one or more batteries 210 in, for example, the form of a button having two or more through channels 220 can be threadingly connected to corresponding conductive contacts 204 via a connecting element 222 such as shown in FIG. 7. It should be noted that one of ordinary skill in the pertinent art would recognize from the present disclosure alternative battery forms (e.g., snaps, beads, rivets, clasps, links, clips, pins, zippers, etc.) that equally may be utilized and that fall within the scope of the present disclosure. Such alternative battery forms need only be sufficiently related to and compatible with garment language so as to be substantially unnoticeable with respect to the garment as a whole (i.e., the battery blends or ties with the garment in an aesthetically and/or functionally appropriate manner).

With reference to FIGS. 8 and 9, an exemplary accessory according to another illustrative aspect of the present disclosure is indicated generally by reference numeral 300. The accessory 300, as shown in FIG. 8, is defined by a number of batteries 310 connected in series to form a circular power band that can, for instance, be worn about a users wrist such as shown in FIG. 9. It is noted however, that any of a variety of other arrangements are equally feasible. For example, one or more electronic applications (e.g., a watch, a light, a monitor and/or any other like device) can be operatively integrated into the band so as to be powered thereby. Additionally, in a preferred aspect of the present disclosure, the accessory 300 can include an application interface 305 that is operatively associated with the various batteries 310 and that provides means for facilitating electrical communication between the batteries 310 of the accessory 300 and a remote electronic application (e.g., a smart garment). It is also noted that as those skilled in the pertinent art will readily recognize additional and/or alternative accessory designs and/or applications, such designs and/or applications, to the extent that they relate to the ideas/concepts disclosed supra, should be considered to fall within the scope of the present disclosure.

The many aspects, features and advantages identified and described herein are apparent from the foregoing detailed discussion and, thus, it is intended by the appended claims to cover all such aspects, features and advantages that fall within the spirit and scope of the present disclosure. Further, since numerous modifications and changes will readily occur to those skilled in the art, it is not desired to limit the scope of the present disclosure to the exact construction and operation illustrated and described, and accordingly all suitable modifications and equivalents may be resorted to as falling within the present disclosures scope. Thus, the exemplary embodiments, aspects and/or features described herein are merely illustrative and the present disclosure specifically encompasses alternative and/or modified embodiments, aspects and/or features of that which has been disclosed.

1. A battery apparatus (10, 110, 210, 310) comprising:
an energy source (12, 112);
a body (14, 114) for accommodating said energy source (12, 112); and
a pair of terminals (16, 18, 116, 118, 316, 318) operatively associated with said energy source (12, 112);
wherein said body (14, 114) includes a through channel (20, 120, 220).

2. The apparatus of claim 1, wherein said terminals (16, 18, 316, 318) are accessible from without said body (14).

3. The apparatus of claim 1, wherein said through channel (20, 120, 220) is suitable for a connecting element (22, 122, 222) to pass therethrough.

4. The apparatus of claim 3, wherein said connecting element (22) is insulative in nature.

5. The apparatus of claim 3, wherein said connecting element (22, 122, 222) is flexible in nature.

6. The apparatus of claim 3, wherein said connecting element (22, 122, 222) is suitable for being either integrated in or attached to a fabric.

7. The apparatus of claim 1, wherein said body (114) includes two through channels (120, 220) through which connecting elements (122, 222) may pass.

8. The apparatus of claim 6, wherein said terminals (116, 118, 316, 318) are exposed internally and each terminal corresponds to one of said two through channels (120, 220).

9. The apparatus of claim 7, wherein each connecting element (122, 222) is conductive in nature and is suitable to convey energy from said energy source (12, 112) to at least one device (208).

10. The apparatus of claim 8, wherein said device (208) is operatively associated with a fabric (28).

11. The apparatus of claim 1 or 6, wherein said connecting element (22, 122, 222) is suitable for simultaneously supporting two or more batteries (10, 110, 210, 310).

12. A battery connecting system comprising:
at least one battery (10, 110, 210, 310) having a body (14, 114) with terminals (16, 18, 116, 118, 316, 318) operatively associated with an energy source (12, 112); and
at least one connecting element (22, 122, 222) cooperative with said at least one battery (10, 110, 210, 310),
wherein said body (14, 114) includes at least one channel (20, 120, 220) through which said connecting element (22, 122, 222) may pass.

13. The system of claim 12, wherein said terminals (16, 18, 316, 318) are external to said body (14).

14. The system of claim 13, wherein said connecting element (22) is nonconductive.

15. The system of claim 12, wherein said terminals (116, 118) are exposed internally and each terminal corresponds to one of two through channels (120, 220).

16. The system of claim 15, wherein each connecting element (122, 222) is conductive in nature and is suitable to convey energy from said energy source (12, 112) to at least one device (208).

17. A method comprising:
providing a first battery (10, 110, 210, 310), said first battery (10, 110, 210, 310) having a pair of first terminals (16, 18, 116, 118, 316, 318) and including at least one through channel (20, 120, 220); and
passing a connecting element (22, 122, 222) through said through channel (20, 120, 220) of said first battery (10, 110, 210, 310) so that said first battery (10, 110, 210, 310) is at least partially supported by said connecting element (22, 122, 222).

18. The method of claim 17, further comprising passing said connecting element (22, 122, 222) through a through channel (20, 120, 220) of a second battery (10, 110, 210, 310), said second battery (10, 110, 210,310) having a pair of second terminals (16, 18, 116, 118, 316, 318), and bringing one of said second terminals into contact with one of said first terminals of said first battery (10, 110, 210, 310) so as to establish a connection therebetween.

19. The method of claim 18, wherein said connecting element (22, 122, 222) is suitable for supporting any number of battery connections.

20. The method of claim 18, wherein said connecting element (22, 122, 222) is suitable for operatively connecting at least one battery (10, 110, 210, 310) to an electrical device or system (206, 208) so as to provide power thereto.
